(19) United States
(12) Patent Application Publication
(10) Pub. No.: US 2014/0178049 A1
(43) Pub. Date: Jun. 26, 2014

(54) IMAGE PROCESSING APPARATUS, IMAGE PROCESSING METHOD, AND PROGRAM

(71) Applicants: Nobuyuki Kihara, Tokyo (JP); Yohei Sakuraba, Kanagawa (JP); Takeshi Yamaguchi, Kanagawa (JP); Yasuhiko Kato, Kanagawa (JP)

(72) Inventors: Nobuyuki Kihara, Tokyo (JP); Yohei Sakuraba, Kanagawa (JP); Takeshi Yamaguchi, Kanagawa (JP); Yasuhiko Kato, Kanagawa (JP)

(73) Assignee: Sony Corporation, Tokyo (JP)

(21) Appl. No.: 13/823,177

(22) PCT Filed: Aug. 1, 2012
(86) PCT No.: PCT/JP2012/069614

§ 371 Date: Apr. 2, 2013

(30) Foreign Application Priority Data
Aug. 16, 2011 (JP) 2011-177831

(51) Int. Cl. G11B 27/036

(52) U.S. Cl. CPC G11B 27/036
USPC 386/280

(57) ABSTRACT

This technology relates to an image processing apparatus, an image processing method, and a program, which enable easier addition of an effect to a moving image.

In a portable terminal device, an ambient environmental sound and a voice uttered by a user are picked up by different sound pickup units when the moving image is shot. A keyword detecting unit detects a keyword determined in advance from the voice uttered by the user and an effect generating unit generates an image effect and a sound effect associated with the detected keyword. Then, an effect adding unit superposes the generated image effect on the shot moving image and synthesizes the generated sound effect with the environmental sound, thereby applying image effects and sound effects to the moving image. According to the portable terminal device, it is possible to easily add a desired effect to the moving image only by uttering the keyword while shooting the moving image. This technology may be applied to a mobile phone.

### TECHNICAL FIELD

This technology relates to an image processing apparatus, an image processing method, and a program, and especially relates to the image processing apparatus, the image processing method, and the program capable of more easily adding an effect to a moving image.

### BACKGROUND ART

A mobile phone, a cam coder, a digital camera and the like are conventionally known as a device capable of shooting the moving image. For example, the mobile phone capable of shooting the moving image, which shoots the moving image by setting a sound with a higher sound level out of the sounds picked up by means of two microphones as the sound associated with the moving image, is suggested (for example, refer to Patent Document 1).

### CITATION LIST

### Patent Document

Patent Document 1: Japanese Patent Application Laid-Open No. 2004-201015

### SUMMARY OF THE INVENTION

### Problems to be Solved by the Invention

Although there is a case in which the effect such as a sound effect is added to the moving image, in general, the effect is often added to the moving image after the moving image is shot, for example, when the moving image is edited.

However, such work to add the effect to the moving image is troublesome. For example, when the effect is to be added after shooting, the user has to select a scene to which the effect is added and perform operation to specify the effect to be added while reproducing the moving image.

Also, along with recent change in video distributing style, application to distribute the shot moving image in real time is increasing. Therefore, technology to easily and rapidly add the effect to the shot moving image is required.

This technology is achieved in consideration of such a situation and this is to add the effect more easily to the moving image.

### Solutions to Problems

An image processing apparatus according to one aspect of this technology is provided with a keyword detecting unit which detects a keyword determined in advance from a voice uttered by a user and picked up by a sound pickup unit different from a sound pickup unit for picking up an environmental sound being a sound associated with a moving image when the moving image is shot; and an effect adding unit which adds an effect determined for the detected keyword to the moving image or the environmental sound.

The image processing apparatus may be further provided with a sound effect generating unit which generates a sound effect based on the detected keyword, wherein the effect adding unit may synthesize the sound effect with the environmental sound.

The image processing apparatus may be further provided with an image effect generating unit which generates an image effect based on the detected keyword, wherein the effect adding unit may superpose the image effect on the moving image.

The image processing apparatus may be further provided with a shooting unit which shoots the moving image; a first sound pickup unit which picks up the environmental sound; and a second sound pickup unit which picks up the voice uttered by the user.

The image processing apparatus may be further provided with a receiving unit which receives the moving image, the environmental sound, and the voice uttered by the user.

An image processing method or a program according to one aspect of this technology includes the step of: detecting a keyword determined in advance from a voice uttered by a user and picked up by a sound pickup unit different from a sound pickup unit for picking up an environmental sound being a sound associated with a moving image when the moving image is shot; and adding an effect determined for the detected keyword to the moving image or the environmental sound.

According to one aspect of this technology, a keyword determined in advance is detected from a voice uttered by a user and picked up by a sound pickup unit different from a sound pickup unit, for picking up an environmental sound being a sound associated with a moving image when the moving image is shot; and an effect determined for the detected keyword is added to the moving image or the environmental sound.

### Effects of the Invention

According to one aspect of this technology, it is possible to more easily add the effect to the moving image.

### BRIEF DESCRIPTION OF DRAWINGS

FIG. 1 is a view for illustrating a summary of this technology.

FIG. 2 is a view illustrating addition of an effect to a moving image.

FIG. 3 is a view illustrating a configuration example of a portable terminal device.

FIG. 4 is a flowchart illustrating an effect adding process.

FIG. 5 is a view illustrating an example of a sound effect correspondence table.

FIG. 6 is a view illustrating an example of an image effect correspondence table.

FIG. 7 is a view illustrating a configuration example of a distribution system.

FIG. 8 is a flowchart illustrating a shooting process and an effect adding process.

FIG. 9 is a view illustrating a configuration example of a computer.

### MODE FOR CARRYING OUT THE INVENTION

Embodiments to which this technology is applied are hereinafter described with reference to the drawings.

### First Embodiment

### [Summary of Technology]

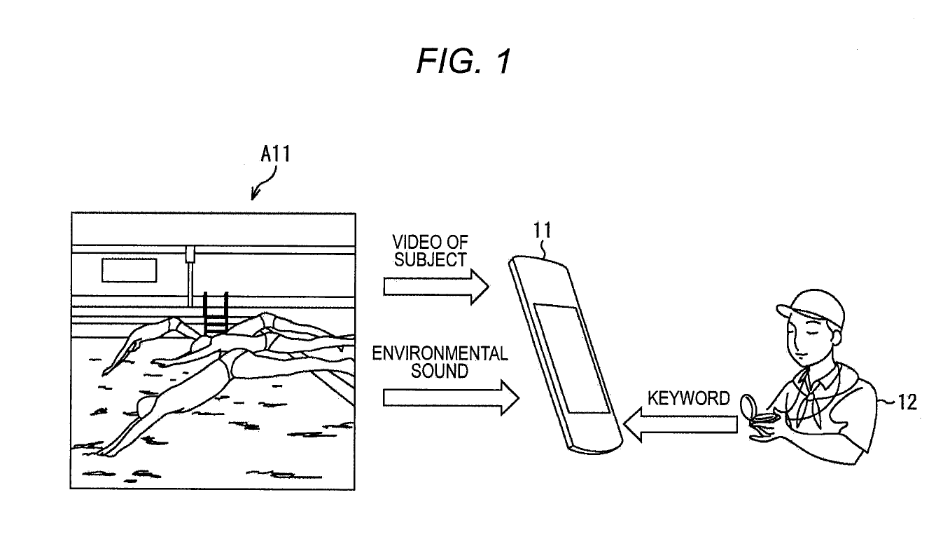

This technology applies sound effects and image effects to a moving image shot by a portable terminal device 11 composed of a mobile phone, a cam coder, a digital camera and the like as illustrated in FIG. 1, for example.

In an example in FIG. 1, a user 12 who operates the portable terminal device 11 shoots the moving image of a player who participates a swimming race as a subject as indicated by an arrow All. That is, the portable terminal device 11 shoots the moving image (video) of the subject according to operation by the user 12 and picks up an ambient sound (hereinafter, referred to as an environmental sound) as a sound associated with the moving image.

Also, during shooting of the moving image, the user 12 utters a word, a phrase or the like (hereinafter, referred to as a keyword) determined in advance for an effect to be added to input the keyword by voice when the user wants to add the effect to a content composed of the moving image and the environmental sound.

The keyword uttered by the user 12 in this manner is picked up by the portable terminal device 11. Meanwhile, the keyword uttered by the user 12 and the environmental sound associated with the moving image are picked up by different sound pickup units. For example, the sound pickup unit, which picks up the environmental sound, and the sound pickup unit, which picks up the keyword, are provided on opposed surfaces of the portable terminal device 11.

When the keyword is detected from the sound obtained by the sound pickup unit for detecting the keyword during the shooting of the moving image, the portable terminal device 11 adds the image effects and the sound effects specified by the keyword to the moving image and the environmental sound obtained by the shooting.

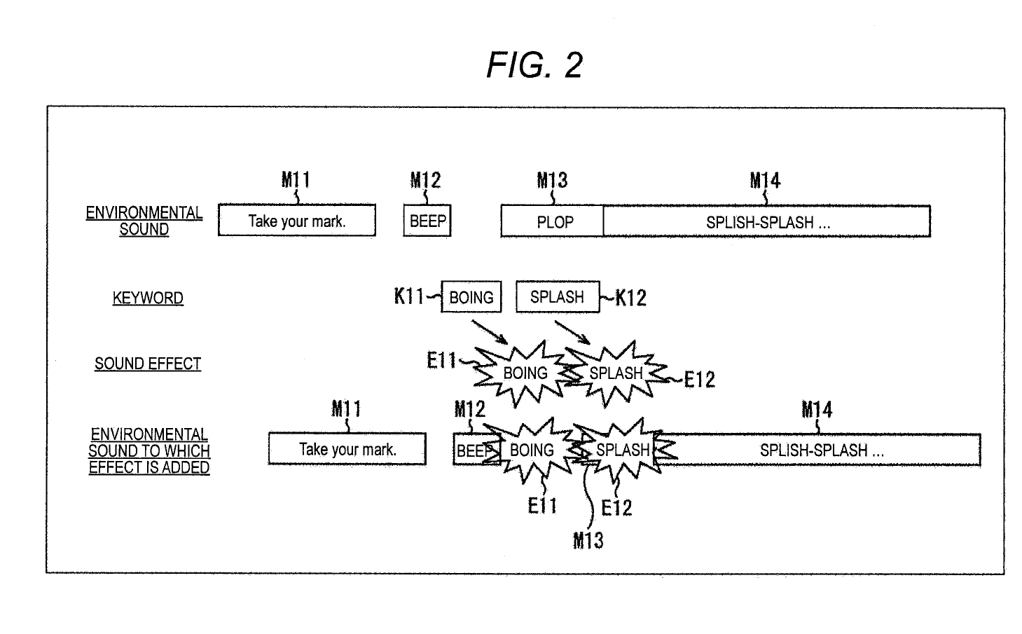

Specifically, for example, it is supposed that, when a starting scene of the swimming race is shot, a sound M11 “Take your mark”, a sound M12 “beep”, a sound M13 “plop”, and a sound M14 “splish-splash” are picked up as the environmental sound as illustrated in FIG. 2.

Meanwhile, in FIG. 2, a horizontal direction represents a time direction and the environmental sound, the keyword, a sound effect, and the environmental sound to which the effect is added are indicated in each position in the time direction.

For example, the sound M11 and the sound M12 are a voice and a whistle indicating a start of the race and the sound M13 and the sound M14 are the sound generated when the player jumps into a pool and the sound generated when the player starts swimming. Also, in an example in FIG. 2, a keyword K11 “boing” uttered by the user is picked up just after the sound M12 of the whistle indicating the start of the race is picked up and a keyword K12 “splash” uttered by the user is picked up substantially simultaneously with the pickup of the sound M13 at the time when the player enters into water.

Further, it is supposed that a sound effect E11 “boing”, which evokes a state in which the subject jumps, is associated with the keyword K11 in advance and a sound effect E12 “splash”, which evokes a state in which a spray of water rises, is associated with the keyword K12 in advance.

In such a case, the portable terminal device 11 synthesizes the sound effect E11 and the sound effect E12 with the environmental sound composed of the picked up sounds M11 to M14 at the time at which the keyword K11 and the keyword K12 are input, respectively, to obtain the environmental sound to which the effect is added. Therefore, when a finally obtained environmental sound to which the effect is added is reproduced, the sound M11, the sound M12, the sound effect E11, the sound M13, the sound effect E12, and the sound M14 are reproduced in this order.

Meanwhile, when an image for applying the image effects (hereinafter, referred to as an image effect) is associated with the keyword in advance, the image effect associated with the detected keyword is synthesized with the moving image obtained by the shooting.

### [Configuration Example of Portable Terminal Device]

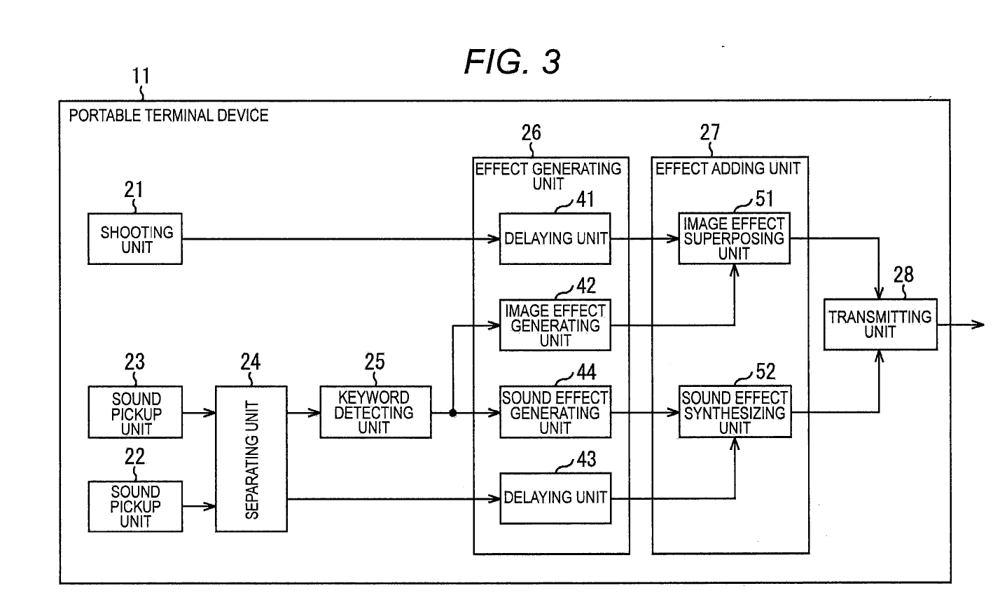

Next, a specific configuration of the portable terminal device 11, which applies the effect to the shot moving image, is described. FIG. 3 is a view illustrating a configuration example of the portable terminal device 11.

The portable terminal device 11 is composed of a shooting unit 21, sound pickup units 22 and 23, a separating unit 24, a keyword detecting unit 25, an effect generating unit 26, an effect adding unit 27, and a transmitting unit 28.

The shooting unit 21 shoots the subject around the portable terminal device 11 according to the operation by the user and supplies image data of the moving image obtained as a result to the effect generating unit 26. The sound pickup unit 22 composed of a microphone and the like, for example, picks up the ambient sound of the portable terminal device 11 as the environmental sound when the moving image is shot and supplies sound data obtained as a result to the separating unit 24.

The sound pickup unit 23 composed of the microphone and the like, for example, picks up the voice (keyword) uttered by the user who operates the portable terminal device 11 during the shooting of the moving image and supplies sound data obtained as a result to the separating unit 24.

Meanwhile, although the sound pickup units 22 and 23 are provided on the different surfaces of the portable terminal device 11, for example, not only the environmental sound but also the voice uttered by the user arrive at the sound pickup unit 22 and not only the voice uttered by the user but also the environmental sound arrive at the sound pickup unit 23. Therefore, in more detail, the sound obtained by the sound pickup unit 22 includes not only the environmental sound but also the voice of the keyword uttered by the user slightly and similarly the sound obtained by the sound pickup unit 23 includes not only the voice of the keyword but also the environmental sound slightly.

The separating unit 24 separates the environmental sound and the voice uttered by the user from each other based on the sound data supplied from the sound pickup unit 22 and the sound data supplied from the sound pickup unit 23.

That is, the separating unit 24 extracts sound data of the environmental sound from the sound data from the sound pickup unit 22 by using the sound data from the sound pickup unit 23 and supplies the sound data of the environmental sound to the effect generating unit 26. Also, the separating unit 24 extracts the sound data of the voice uttered by the user from the sound data from the sound pickup unit 23 by using the sound data from the sound pickup unit 22 and supplies the sound data of the voice uttered by the user to the keyword detecting unit 25.

The keyword detecting unit 25 detects the keyword from the voice based on the sound data supplied from the separating unit 24 and supplies a detection result to the effect generating unit 26.

The effect generating unit 26 supplies the image data of the moving image from the shooting unit 21 and the sound data of the environmental sound from the separating unit 24 to the effect adding unit 27 and generates the effect to be added to the moving image based on the detection result of the keyword from the keyword detecting unit 25 to supply to the effect adding unit 27.

The effect generating unit 26 is provided with a delaying unit 41, an image effect generating unit 42, a delaying unit 43, and a sound effect generating unit 44.

The delaying unit 41 temporarily holds the image data of the moving image supplied from the shooting unit 21 to delay and supplies the same to the effect adding unit 27. The image effect generating unit 42 generates image data of the image effect for applying the image effects based on the detection result supplied from the keyword detecting unit 25 and supplies the same to the effect adding unit 27.

The delaying unit 43 temporarily holds the sound data of the environmental sound supplied from the separating unit 24 to delay and supplies the same to the effect adding unit 27. The sound effect generating unit 44 generates sound data of the sound effect for applying the sound effects based on the detection result supplied from the keyword detecting unit 25 and supplies the same to the effect adding unit 27.

The effect adding unit 27 adds the effect to the moving image and the environmental sound based on the moving image, the environmental sound, the image effect, and the sound effect supplied from the effect generating unit 26 and supplies the same to the transmitting unit 28. The effect adding unit 27 is provided with an image effect superposing unit 51 and a sound effect synthesizing unit 52.

The image effect superposing unit 51 superposes the image data of the image effect supplied from the image effect generating unit 42 on the image data of the moving image supplied from the delaying unit 41 and supplies the same to the transmitting unit 28. The sound effect synthesizing unit 52 synthesizes the sound data of the sound effect supplied from the sound effect generating unit 44 with the sound data of the environmental sound supplied from the delaying unit 43 and supplies the same to the transmitting unit 28.

The transmitting unit 28 transmits the image data supplied from the image effect superposing unit 51 and the sound data supplied from the sound effect synthesizing unit 52 to an external device as one content composed of the video and the sound.

### [Description of Effect Adding Process]

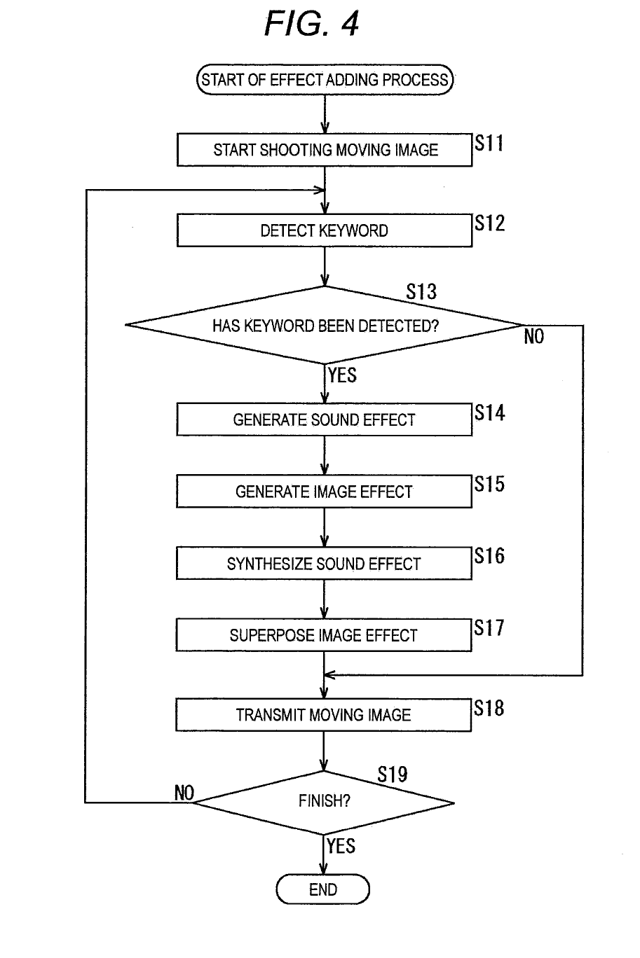

When the user operates the portable terminal device 11 to give an instruction to start shooting the moving image, the portable terminal device 11 shoots the moving image and performs an effect adding process to add the effect to the moving image obtained by the shooting according to the keyword uttered by the user. The effect adding process by the portable terminal device 11 is hereinafter described with reference to a flowchart in FIG. 4.

At step S11, the shooting unit 21 starts shooting the moving image, supplies the image data obtained by the shooting to the delaying unit 41 and allows the same to hold the data.

When the shooting of the moving image is started, the sound pickup units 22 and 23 also start picking up the ambient sound and supply the obtained sound data to the separating unit 24. That is, the sound pickup unit 22 picks up the environmental sound as the sound associated with the moving image and the sound pickup unit 23 picks up the keyword (voice) uttered by the user.

Further, the separating unit 24 removes a component of the voice (keyword) uttered by the user from the sound data from the sound pickup unit 22 based on the sound data from the sound pickup unit 23 by utilizing a difference in sound pressure of the sound and the like, supplies the sound data of the environmental sound obtained as a result to the delaying unit 43 and allows the same to hold the data. Similarly, the separating unit 24 removes a component of the environmental sound from the sound data from the sound pickup unit 23 by using the sound data from the sound pickup unit 22 and supplies the sound data of the voice (keyword) uttered by the user obtained as a result to the keyword detecting unit 25. By the processes, the environmental sound and the keyword are separated from each other.

At step S12, the keyword detecting unit 25 detects the keyword from the voice uttered by the user by performing a voice recognition process and the like of the sound data supplied from the separating unit 24. For example, the keyword determined in advance such as the keyword K11 and the keyword K12 illustrated in FIG. 2 is detected from the voice uttered by the user.

At step S13, the keyword detecting unit 25 judges whether the keyword is detected. When it is judged that the keyword is detected at step S13, the keyword detecting unit 25 supplies information, which specifies the detected keyword, to the image effect generating unit 42 and the sound effect generating unit 44 and the procedure shifts to step S14.

At step S14, the sound effect generating unit 44 generates the sound effect based on the information supplied from the keyword detecting unit 25 and supplies the same to the sound effect synthesizing unit 52.

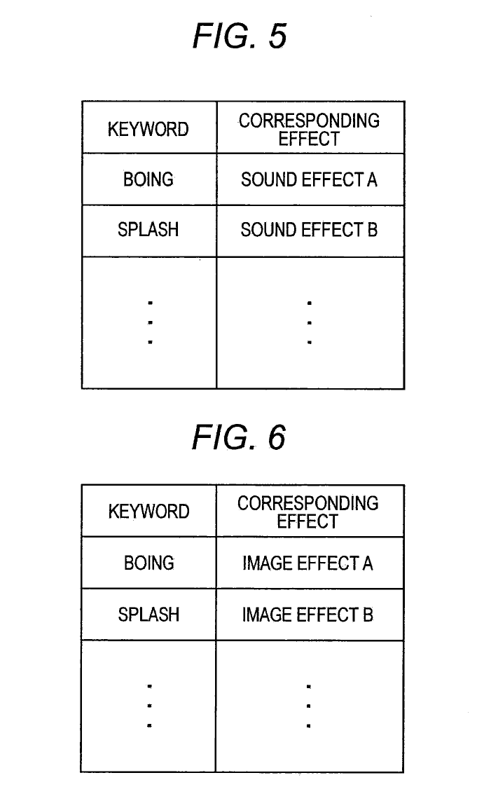

For example, the sound effect generating unit 44 records a sound effect correspondence table in which the keyword determined in advance and the sound effect specified by the keyword are associated with each other as illustrated in FIG. 5. In an example in FIG. 5, a sound effect “sound effect A” is associated with the keyword “boing” and a sound effect “sound effect B” is associated with the keyword “splash”.

The sound effect generating unit 44 specifies the sound effect corresponding to the keyword indicated by the information supplied from the keyword detecting unit 25 by referring to the sound effect correspondence table and reads out the specified sound effect out of a plurality of sound effect recorded in advance to supply to the sound effect synthesizing unit 52. Therefore, when the keyword “boing” is detected by the keyword detecting unit 25, for example, the sound effect generating unit 44 supplies the sound data of the “sound effect A” corresponding to the “boing” to the sound effect synthesizing unit 52.

At step S15, the image effect generating unit 42 generates the image effect based on the information supplied from the keyword detecting unit 25 and supplies the same to the image effect superposing unit 51.

For example, the image effect generating unit 42 records an image effect correspondence table in which the keyword determined in advance and the image effect specified by the keyword are associated with each other as illustrated in FIG. 6.

In an example in FIG. 6, an image effect “image effect A” is associated with the keyword “boing” and an image effect “image effect B” is associated with the keyword “splash”. For example, the image effects are an image including a character indicating the keyword, an animation image related to the keyword and the like.

The image effect generating unit 42 specifies the image effect corresponding to the keyword indicated by the information supplied from the keyword detecting unit 25 by referring to the image effect correspondence table and reads out the specified image effect out of a plurality of image effect recorded in advance to supply to the image effect superposing unit 51.

Meanwhile, although a case in which the sound effect and the image effect specified by the keyword are read out by the sound effect generating unit 44 and the image effect generating unit 42, respectively, is described as an example, it is also possible that the sound effect and the image effect are generated based on the detected keyword and the data recorded in advance.

It is also possible that both of the sound effect and the image effect are associated with each keyword and that any one of the sound effect and the image effect is associated with each keyword. For example, when only the sound effect is associated with a predetermined keyword, the image effect generating unit 42 does not generate the image effect even when the keyword is detected and the effect is applied only to the environmental sound out of the moving image and the environmental sound.

The flowchart in FIG. 4 is described again; at step S16, the sound effect synthesizing unit 52 obtains the sound data of the environmental sound from the delaying unit 43 and synthesizes the obtained sound data with the sound data of the sound effect supplied from the sound effect generating unit 44 to supply to the transmitting unit 28.

At that time, the sound effect synthesizing unit 52 performs a synthesizing process while synchronizing the sound data of the environmental sound with the sound data of the sound effect such that the sound effect is reproduced at the time (reproduction time) at which the keyword is uttered by the user during the shooting of the moving image when the environmental sound to which the sound effect is synthesized is reproduced. The sound data for reproducing the environmental sound and the sound effect is obtained by such synthesizing process. That is, the sound in which the keyword uttered by the user out of the ambient sound while the moving image is shot is replaced with the sound effect is obtained.

At step S17, the image effect superposing unit 51 obtains the image data of the moving image from the delaying unit 41 and superposes the image data of the image effect supplied from the image effect generating unit 42 on the obtained image data to supply to the transmitting unit 28.

At that time, the image effect superposing unit 51 performs a superposing process while synchronizing the image data of the moving image with the image data of the image effect such that the image effect is displayed at the time at which the user utters the keyword during the shooting of the moving image when the moving image to which the image effect is synthesized is reproduced. The image data of the moving image in which the image effect such as the character “boing” indicating the keyword is displayed together with the shot subject is obtained by such superposing process.

Meanwhile, the image effects for the shot moving image are not limited to superposition of the image effect and they may be any type of effect such as a fading effect and a flash effect for the moving image may be used. For example, when the fading effect is associated with a predetermined keyword as the image effects, the image effect generating unit 42 supplies information indicating that the fading effect is applied to the moving image to the image effect superposing unit 51. Then, the image effect superposing unit 51 performs image processing to apply the fading effect to the moving image from the delaying unit 41 based on the information supplied from the image effect generating unit 42.

When the effect is applied to the shot moving image and the environmental sound in the above-described manner, the procedure shifts from step S17 to step S18.

Also, when it is judged that the keyword is not detected at step S13, the image effect and the sound effect are not added, so that the processes from step S14 to step S17 are not performed and the procedure shifts to step S18. At that time, the image effect superposing unit 51 obtains the moving image from the delaying unit 41 and supplies the same to the transmitting unit 28 as is, and the sound effect synthesizing unit 52 obtains the environmental sound from the delaying unit 43 and supplies the same to the transmitting unit 28 as is.

When it is judged that the keyword is not detected at step S13 or when the image effect is superposed at step S17, the transmitting unit 28 transmits the moving image from the image effect superposing unit 51 and the environmental sound from the sound effect synthesizing unit 52 at step S18.

That is, the transmitting unit 28 multiplexes the image data of the moving image from the image effect superposing unit 51 and the sound data of the environmental sound from the sound effect synthesizing unit 52 to make data of one content. Then, the transmitting unit 28 distributes the obtained data to a plurality of terminal device connected through a network or uploads the same to a server, which distributes the content.

At step S19, the portable terminal device 11 judges whether to finish the process to add the effect to the moving image. For example, when the user operates the portable terminal device 11 to give an instruction to finish shooting the moving image, it is judged that the process is finished.

When it is judged that the process is not finished yet at step S19, the procedure returns to step S12 and the above-described processes are repeated. That is, the process to apply the image effects and the sound effects to a newly shot moving image and a newly picked up environmental sound, respectively, is performed.

On the other hand, when it is judged that the process is finished at step S19, each unit of the portable terminal device 11 stops the process, which is being performed, and the effect adding process is finished.

In this manner, the portable terminal device 11 picks up the keyword uttered by the user during the shooting of the moving image and adds the effect corresponding to the keyword to the shot moving image and the picked up environmental sound. According to this, the user may easily and rapidly add the effect only by uttering the keyword corresponding to a desired effect during the shooting of the moving image.

When the user inputs the keyword by voice in this manner, the user is not required to specify a site to which the effect is added and the effect to be added by reproducing the moving image after the shooting. Troublesome operation such as to register the effects on many buttons and the like and to press the button corresponding to the effect, which is wanted to be added, while the moving image is reproduced, for example, is not required, so that it is possible to efficiently add the effect to the moving image. Also, although the number of effects, which may be registered, is limited by the number of buttons when the effect is registered on each button, it is possible to register more effects if the effect is associated with the keyword.

Further, the portable terminal device 11 is capable of adding the effect to the moving image simultaneously with the shooting of the moving image, so that this may distribute the moving image to which the effect is added in real time.

### Second Embodiment

### [Configuration Example of Distribution System]

Meanwhile, although a case in which an effect is added to a moving image in a portable terminal device, which shoots the moving image, is described above, it is also possible that the moving image, an environmental sound, and a voice of a keyword obtained by shooting are transmitted to a server and the effect is added on a server side.

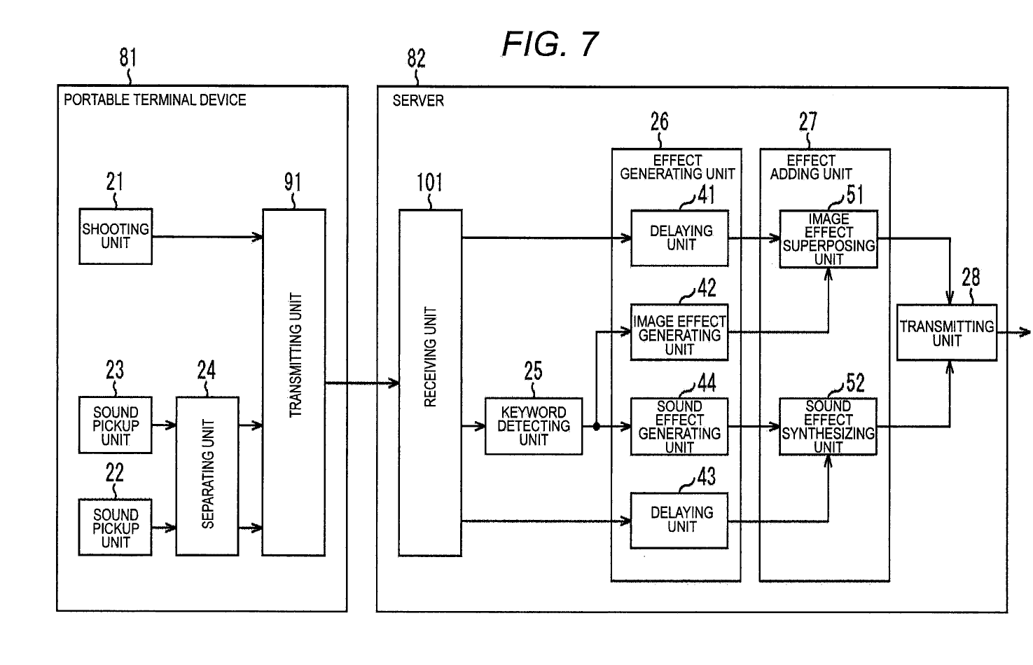

In such a case, a distribution system of the moving image composed of the portable terminal device, which shoots the moving image, and the server, which adds the effect to the moving image, is composed as illustrated in FIG. 7, for example. Meanwhile, in FIG. 7, the same reference sign is assigned to a part corresponding to that in FIG. 3 and the description thereof is appropriately omitted.

The distribution system illustrated in FIG. 7 is composed of a portable terminal device 81 and a server 82, and the portable terminal device 81 and the server 82 are connected to each other through a communication network such as the Internet.

The portable terminal device 81 is composed of a shooting unit 21, sound pickup units 22 and 23, a separating unit 24, and a transmitting unit 91. The transmitting unit 91 transmits image data of the moving image supplied from the shooting unit 21, sound data of the environmental sound supplied from the separating unit 24, and sound data of a voice uttered by a user to the server 82.

Also, the server 82 is composed of a receiving unit 101, a keyword detecting unit 25, an effect generating unit 26, an effect adding unit 27, and a transmitting unit 28.

Meanwhile, configurations of the effect generating unit 26 and the effect adding unit 27 of the server 82 are the same as the configurations of the effect generating unit 26 and the effect adding unit 27 of a portable terminal device 11 in FIG. 3. That is, a delaying unit 41, an image effect generating unit 42, a delaying unit 43, and a sound effect generating unit 44 are provided on the effect generating unit 26 of the server 82 and an image effect superposing unit 51 and a sound effect synthesizing unit 52 are provided on the effect adding unit 27 of the server 82.

The receiving unit 101 receives the image data of the moving image, the sound data of the environmental sound, and the sound data of the voice uttered by the user transmitted from the portable terminal device 81 and supplies the received data to the delaying units 41 and 43 and the keyword detecting unit 25, respectively.

### [Description of Shooting Process and Effect Adding Process]

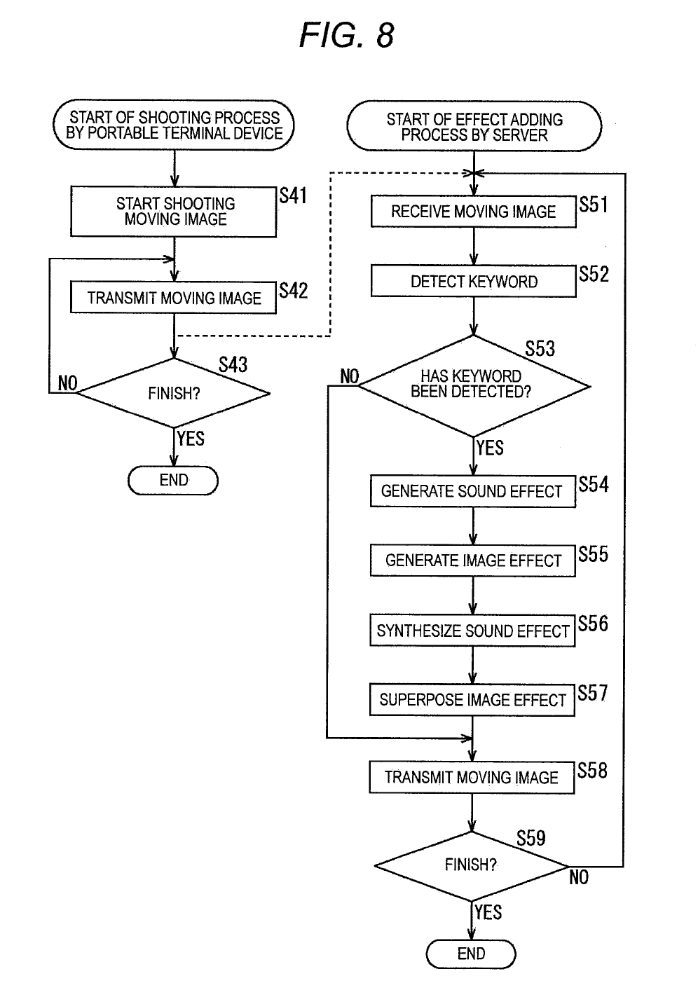

Next, a shooting process by the portable terminal device 81 and an effect adding process by the server 82 are described with reference to a flowchart in FIG. 8.

At step S41, the shooting unit 21 starts shooting the moving image according to operation by the user and supplies the image data of the moving image obtained by the shooting to the transmitting unit 91.

When the shooting of the moving image is started, the sound pickup units 22 and 23 also start picking up an ambient sound and supply obtained sound data to the separating unit 24. Further, the separating unit 24 extracts the sound data of the environmental sound and the sound data of the voice (keyword) uttered by the user based on the sound data supplied from the sound pickup units 22 and 23 and supplies the same to the transmitting unit 91.

In more detail, the separating unit 24 adds specifying information to the sound data of the environmental sound indicating that this is the sound data of the environmental sound and adds specifying information to the sound data of the voice uttered by the user indicating that this is the sound data of the keyword. Then, the sound data to which the specifying information is added is supplied to the transmitting unit 91.

At step S42, the transmitting unit 91 transmits the shot moving image to the server 82. That is, the transmitting unit 91 stores the image data of the moving image supplied from the shooting unit 21, the sound data of the environmental sound and the sound data of the voice uttered by the user supplied from the separating unit 24 in packets and the like as needed and transmits the same to the server 82.

At step S43, the portable terminal device 81 judges whether to finish the process to transmit the moving image to the server 82. For example, when the user gives an instruction to finish shooting the moving image, it is judged that the process is finished.

When it is judged that the process is not finished at step S43, the procedure returns to step S42 and the above-described processes are repeated. That is, a newly shot moving image, a newly picked up environmental sound and the like are transmitted to the server 82.

On the other hand, when it is judged that the process is finished at step S43, the transmitting unit 91 transmits information indicating that transmission of the moving image is completed to the server 82 and the shooting process is finished.

Also, when the image data and the sound data are transmitted to the server 82 at step S42, the server 82 performs the effect adding process in response to the same.

That is, at step S51, the receiving unit 101 receives the image data of the moving image, the sound data of the environmental sound, and the sound data of the voice uttered by the user transmitted from the transmitting unit 91 of the portable terminal device 81.

Then, the receiving unit 101 supplies the image data of the received moving image to the delaying unit 41 and allows the same to hold the data, and supplies the sound data of the received environmental sound to the delaying unit 43 and allows the same to hold the data. The receiving unit 101 also supplies the received sound data of the voice uttered by the user to the keyword detecting unit 25.

Meanwhile, the sound data of the environmental sound and the sound data of the voice uttered by the user are specified by the specifying information added to the sound data.

When the moving image is received, processes from step S52 to step S58 are performed thereafter and the effect is added to the moving image and the environmental sound; however, since the processes are similar to those from step S12 to step S18 in FIG. 4, the description thereof is omitted.

At step S59, the server 82 judges whether to finish the process to add the effect to the moving image. For example, when the receiving unit 101 receives the information indicating that the transmission of the moving image is completed, it is judged that the process is finished.

When it is judged that the process is not finished yet at step S59, the procedure returns to step S51 and the above-described processes are repeated. That is, the new moving image transmitted from the portable terminal device 81 is received and the effect is added to the moving image.

On the other hand, when it is judged that the process is finished at step S59, each unit of the server 82 stops the process, which is being performed, and the effect adding process is finished. Meanwhile, it is also possible that the moving image to which the effect is added is recorded on the server 82 or transmitted to the portable terminal device 81 as is.

In this manner, the portable terminal device 81 shoots the moving image, picks up the ambient sound, and transmits the obtained image data and sound data to the server 82. Also, the server 82 receives the image data and the sound data transmitted from the portable terminal device 81 and adds the effect to the moving image and the environmental sound according to the keyword included in the sound.

In this manner, also when the server 82 receives the moving image and the like, the user may easily and rapidly add the effect only by uttering the keyword corresponding to the effect, which is wanted to be added, during the shooting of the moving image.

Meanwhile, although an example in which the image data and the two sound data are transmitted to the server 82 to be processed is described in the second embodiment, it is also possible that the portable terminal device 81 is provided with the keyword detecting unit 25 and the keyword is detected on a portable terminal device 81 side.

In such a case, the keyword detecting unit 25 detects the keyword based on the sound data of the voice uttered by the user extracted by the separating unit 24 and supplies information indicating the detected keyword such as a code, which specifies the keyword, for example, to the transmitting unit 91. Then, the transmitting unit 91 transmits the moving image from the shooting unit 21, the information indicating the keyword supplied from the keyword detecting unit 25, and the environmental sound from the separating unit 24 to the server 82.

Also, the server 82, which receives the moving image, the information indicating the keyword, and the environmental sound, adds the effect to the moving image and the environmental sound based on the keyword specified by the received information.

Further, it is also possible to provide the separating unit 24 on the server 82 such that the environmental sound and the voice uttered by the user are separated from each other on a server 82 side.

In such a case, the transmitting unit 91 of the portable terminal device 81 transmits the image data of the moving image obtained by the shooting unit 21, the sound data obtained by the sound pickup unit 22, and the sound data obtained by the sound pickup unit 23 to the server 82.

At that time, the transmitting unit 91 adds the specifying information for specifying the sound pickup unit, which picks up the sound of the sound data, to each sound data. For example, the specifying information indicating the sound pickup unit 22 for picking up the environmental sound is added to the sound data obtained by the sound pickup unit 22. According to this, it becomes possible that the separating unit 24 on the server 82 side specifies whether the sound data received by the receiving unit 101 is the sound data of the sound picked up by the sound pickup unit 22 for picking up the environmental sound or the sound data of the sound picked up by the sound pickup unit 23 for picking up the keyword.

When the separating unit 24 on the server 82 side separates the sounds based on the sound data received by the receiving unit 101, the separating unit 24 supplies the sound data of the environmental sound obtained as a result to the delaying unit 43 and supplies the sound data of the voice uttered by the user to the keyword detecting unit 25.

Further, the above-described series of processes may be executed by hardware or may be executed by software. When a series of processes are executed by the software, a program, which composes the software, is installed from a program recording medium on a computer embedded in dedicated hardware or a general-purpose personal computer, for example, capable of executing various functions with various programs installed.

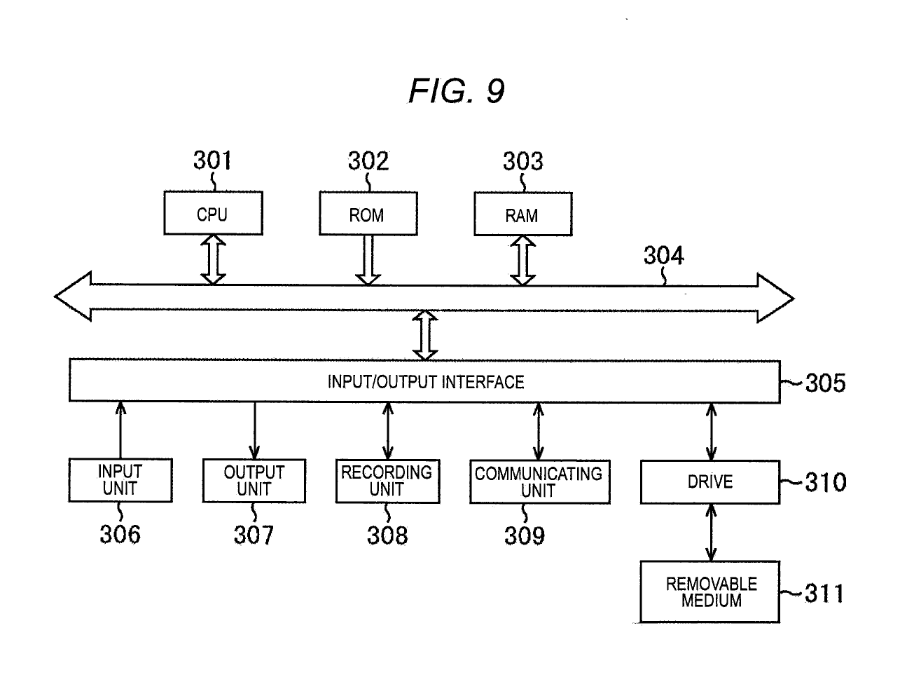

FIG. 9 is a block diagram illustrating a configuration example of the hardware of the computer, which executes the above-described series of processes by the program.

In this computer, a CPU (Central Processing Unit) 301, a ROM (Read Only Memory) 302, and a RAM (Random Access Memory) 303 are connected to one another through a bus 304.

An input/output interface 305 is further connected to the bus 304. An input unit 306 composed of a keyboard, a mouse, a microphone, a camera and the like, an output unit 307 composed of a display, a speaker and the like, a recording unit 308 composed of a hard disc, a nonvolatile memory and the like, a communicating unit 309 composed of a network interface and the like, and a drive 310, which drives a removable medium 311 such as a magnetic disc, an optical disc, a magnetooptical disc, or a semiconductor memory are connected to the input/output interface 305.

In the computer configured as described above, the CPU 301 loads the program recorded in the recording unit 308 on the RAM 303 through the input/output interface 305 and the bus 304 to execute, for example, and according to this, the above-described series of processes are performed.

The program executed by the computer (CPU 301) is provided in a state of being recorded on the removable medium 311, which is a package medium composed of the magnetic disc (including a flexible disc), the optical disc (CD-ROM (Compact Disc-Read Only Memory), a DVD (Digital Versatile Disc) and the like), the magnetooptical disc, or the semiconductor memory, for example, or through a wired or wireless transmission medium such as a local area network, the Internet, and a digital satellite broadcasting.

The program may be installed on the recording unit 308 through the input/output interface 305 by mounting of the removable medium 311 on the drive 310. Also, the program may be received by the communicating unit 309 through the wired or wireless transmission medium to be installed on the recording unit 308. In addition, the program may be installed in advance on the ROM 302 and the recording unit 308.

Meanwhile, the program executed by the computer may be the program of which process is performed in chronological order in the order described in this description or may be the program of which process is performed in parallel or when required such as when a call is issued.

Also, the embodiment of this technology is not limited to the above-described embodiments and various modifications may be made without departing from the scope of this technology.

Further, this technology may have a following configuration.

[1]

An image processing apparatus, including:

a keyword detecting unit which detects a keyword determined in advance from a voice uttered by a user and picked up by a sound pickup unit different from a sound pickup unit for picking up an environmental sound being a sound associated with a moving image when the moving image is shot; and

an effect adding unit, which adds an effect determined for the detected keyword to the moving image or the environmental sound.

[2]

The image processing apparatus according to [1], further including:

a sound effect generating unit which generates a sound effect based on the detected keyword, wherein

the effect adding unit synthesizes the sound effect with the environmental sound.

[3]

The image processing apparatus according to [1] or [2], further including:

an image effect generating unit which generates an image effect based on the detected keyword, wherein

the effect adding unit superposes the image effect on the moving image.

[4]

The image processing apparatus according to any of [1] to [3], further including:

a shooting unit which shoots the moving image;

a first sound pickup unit which picks up the environmental sound; and

a second sound pickup unit which picks up the voice uttered by the user.

[5]

The image processing apparatus according to any of [1] to [3], further including:

a receiving unit which receives the moving image, the environmental sound, and the voice uttered by the user.

### REFERENCE SIGNS LIST

11 portable terminal device, 21 shooting unit, 22 sound pickup unit, 23 sound pickup unit, 25 keyword detecting unit, 26 effect generating unit, 27 effect adding unit, 28 transmitting unit, 42 image effect generating unit, 44 sound effect generating unit, 51 image effect superposing unit, 52 sound effect synthesizing unit, 82 server, 101 receiving unit

1. An image processing apparatus, comprising:
a keyword detecting unit which detects a keyword determined in advance from a voice uttered by a user and picked up by a sound pickup unit different from a sound pickup unit for picking up an environmental sound being a sound associated with a moving image when the moving image is shot; and
an effect adding unit which adds an effect determined for the detected keyword to the moving image or the environmental sound.

2. The image processing apparatus according to claim 1, further comprising:
a sound effect generating unit which generates a sound effect based on the detected keyword, wherein
the effect adding unit synthesizes the sound effect with the environmental sound.

3. The image processing apparatus according to claim 2, further comprising:
an image effect generating unit which generates an image effect based on the detected keyword, wherein
the effect adding unit superposes the image effect on the moving image.

4. The image processing apparatus according to claim 3, further comprising:
a shooting unit which shoots the moving image;
a first sound pickup unit which picks up the environmental sound; and
a second sound pickup unit which picks up the voice uttered by the user.

5. The image processing apparatus according to claim 3, further comprising:
a receiving unit which receives the moving image, the environmental sound, and the voice uttered by the user.

6. An image processing method to be performed by an image processing apparatus including:
a keyword detecting unit which detects a keyword determined in advance from a voice uttered by a user and picked up by a sound pickup unit different from a sound pickup unit for picking up an environmental sound being a sound associated with a moving image when the moving image is shot; and
an effect adding unit which adds an effect determined for the detected keyword to the moving image or the environmental sound,
the image processing method comprising the steps at which:
the keyword detecting unit detects the keyword; and
the effect adding unit adds the effect to the moving image or the environmental sound.

7. A program for causing a computer to execute a process including the steps of:
detecting a keyword determined in advance from a voice uttered by a user and picked up by a sound pickup unit different from a sound pickup unit for picking up an environmental sound being a sound associated with a moving image when the moving image is shot; and
adding an effect determined for the detected keyword to the moving image or the environmental sound.
